(19) United States
(12) Patent Application Publication
(10) Pub. No.: US 2011/0268994 A1
(43) Pub. Date: Nov. 3, 2011

(54) GLASS SUBSTRATE FOR INFORMATION RECORDING MEDIUM, POLISHING COLLOIDAL SILICA SLURRY FOR MANUFACTURING THE SAME AND INFORMATION RECORDING MEDIUM

(75) Inventor: Katsuaki MIYATANI, Tokyo (JP)

(73) Assignee: Asahi Glass Company, Limited, Chiyoda-ku (JP)

(21) Appl. No.: 13/093,195

(22) Filed: Apr. 25, 2011

(30) Foreign Application Priority Data
Apr. 28, 2010 (JP) 2010-103510

(51) Int. Cl. G11B 5/73; C09G 1/02; B24B 1/00; G11B 5/84

(52) U.S. Cl. 428/846.9; 428/64.2; 51/308; 451/41

(57) ABSTRACT

The present invention relates to a colloidal silica slurry used in a method for manufacturing a glass substrate for an information recording medium, the method including: a lapping step of lapping a main surface of a circular glass plate; a subsequent cerium oxide polishing step of polishing the main surface of the circular glass plate with a slurry containing a cerium oxide abrasive; and a colloidal silica polishing step of polishing the main surface of the circular glass plate with a slurry containing a colloidal silica abrasive after the cerium oxide polishing step, in which the colloidal silica abrasive has a BET average particle size determined by a BET specific surface area measuring method of 40 nm or less, and a smoothness index represented by a ratio (BET average particle size (nm)/Circularity) of the BET average particle size and a circularity indicated by 4·π·S/L² in which an area per one particle of the colloidal silica abrasive is taken as S and an outer peripheral length thereof is taken as L, of 50 nm or less.

### FIELD OF THE INVENTION

The present invention relates to a glass substrate for an information recording medium (hereinafter also briefly referred to as a “glass substrate”), a polishing colloidal silica slurry for manufacturing the same and an information recording medium.

### BACKGROUND OF THE INVENTION

In recent years, it has been essential to increase the performance of magnetic films toward an increase in capacity of hard disks. In order to improve the performance of the magnetic films, a decrease in surface roughness Ra is required for glass substrates used therein.

In order to realize the decrease in surface roughness Ra, the glass substrates are polished using finer abrasives. In general, as the polishing abrasive having a size of 100 nm or less, cerium oxide or aluminum oxide has been partially used. However, finish polishing has been performed using a colloidal silica slurry in most cases.

From such a background, for example, the addition of anionic additives for improving flatness has been proposed, as well as adjustment of the abrasive particle size (for example, see Patent Documents 1 and 2).

Patent Document 1: JP-A-2008-155368 (Claims)

Patent Document 2: JP-A-2007-191696 (Claims)

### SUMMARY OF THE INVENTION

However, as a result of verification of the foregoing anionic additives, the present inventors have confirmed that the effect of being able to improve the surface roughness Ra of the glass substrates is small. In order to improve the recording density, main surfaces of the glass substrates will be demanded to have a surface roughness Ra of 0.15 nm or less in the future. It is therefore anticipated that only the addition of the anionic additive will make it difficult to deal therewith.

The invention has been made in view of the foregoing problems, and an object of the invention is to provide a glass substrate having a low surface roughness in a method of manufacturing the glass substrate through a step of polishing a circular glass plate by using a slurry containing a colloidal silica abrasive.

Colloidal silica is generally classified into two types: colloidal silica in which water glass is used as a raw material and high-purity colloidal silica in which an organic silicate is used. In the case of glass polishing, the colloidal silica in which water glass is used as a raw material is preferably used in general. However, in the colloidal silica in which water glass is used as a raw material, it becomes difficult to make the particle shape uniform with a decrease in abrasive size, and the deviation from a true sphere also becomes large. Accordingly, even when the particle size of the colloidal silica is simply decreased, the surface roughness Ra is not sufficiently decreased in some cases.

Then, the present inventors have considered that a parameter other than the particle size has an influence on the surface roughness Ra, have searched colloidal silica of various types, and have examined the relationships between a particle size measuring method and the surface roughness Ra and between a particle shape measuring method and the surface roughness Ra. As a result, it has been found that the correlation between the particle size measured by using a dynamic scattering method as the common particle size measuring method and the surface roughness Ra is small.

Further, the circularity has been determined by analyzing the average particle size determined by a BET specific surface area measuring method (hereinafter referred to as the “BET average particle size) and the particle shape obtained by TEM observation. As a result, it has been found that the smoothness index defined by BET average particle size (nm)/circularity and the surface roughness Ra have a high correlation, and further that when each of the BET average particle size and the smoothness index is a specific value or less, the surface roughness Ra also decreases to a desired value of 0.15 nm or less, thus leading to completion of the invention.

That is to say, in order to achieve the foregoing object, the invention provides a glass substrate for an information recording medium, a polishing colloidal silica slurry for manufacturing the same and an information recording medium, which are shown below.

(1) A colloidal silica slurry used in a method for manufacturing a glass substrate for an information recording medium, said method comprising: a lapping step of lapping a main surface of a circular glass plate; a subsequent cerium oxide polishing step of polishing the main surface of the circular glass plate with a slurry containing a cerium oxide abrasive; and a colloidal silica polishing step of polishing the main surface of the circular glass plate with a slurry containing a colloidal silica abrasive after the cerium oxide polishing step,

wherein the colloidal silica abrasive has a BET average particle size determined by a BET specific surface area measuring method of 40 nm or less, and

a smoothness index represented by a ratio (BET average particle size (nm)/Circularity) of the BET average particle size and a circularity indicated by 4·π·S/L² in which an area per one particle of the colloidal silica abrasive is taken as S and an outer peripheral length thereof is taken as L, of 50 nm or less.

(2) The colloidal silica slurry according to (1), wherein the colloidal silica slurry has a pH of from 1.5 to 2.5.

(3) The colloidal silica slurry according to (1) or (2), wherein the colloidal silica slurry contains an acid, and the acid is at least one selected from the group consisting of hydrochloric acid, sulfuric acid, nitric acid and sulfurous acid.

(4) The colloidal silica slurry according to any one of (1) to (3), wherein the colloidal silica abrasive is manufactured by a water glass method.

(5) The colloidal silica slurry according to any one of (1) to (4), which is for polishing a circular Al₂O₃-SiO₂-based glass plate.

(6) A method for manufacturing a glass substrate for an information recording medium, said method comprising:

a lapping step of lapping a main surface of a circular glass plate;

a cerium oxide polishing step of polishing the main surface of the circular glass plate with a slurry containing a cerium oxide abrasive after the lapping step; and

a colloidal silica polishing step of polishing the main surface of the circular glass plate with the colloidal silica slurry according to any one of (1) to (5) after the cerium oxide polishing step.

(7) The method for manufacturing a glass substrate for an information recording medium according to (6), wherein the circular glass plate is a circular Al₂O₃-SiO₂-based glass plate.

(8) A glass substrate for an information recording medium obtained by the manufacturing method according to (6) or (7).

(9) The glass substrate for an information recording medium according to (8), wherein a main surface of the glass substrate has a surface roughness Ra of 0.15 nm or less.

(10) A magnetic recording medium comprising a magnetic recording layer provided on the main surface of the glass substrate for an information recording medium according to (8) or (9).

According to the present invention, the surface roughness Ra of a glass substrate measured under an atomic force microscope (AFM) is adjusted to 0.15 nm or less by polishing the glass substrate using a colloidal silica abrasive having a BET average particle size of 40 nm or less and a smoothness index of 50 nm or less, and there is provided a glass substrate for a magnetic recording medium which can thoroughly deal with a high recording capacity which will be demanded in the future.

### DETAILED DESCRIPTION OF THE INVENTION

The invention will be described in detail below, taking the manufacture of a glass substrate for a magnetic disk (glass substrate for a hard disk, hereinafter briefly referred to as a “glass substrate”) as an example.

In the invention, a circular glass plate comprising, for example, Al₂O₃-SiO₂-based glass (aluminosilicate glass) is used as a starting raw material. Then, the glass substrate is usually manufactured through respective steps as listed below. That is to say, a circular hole is cored in the center of the circular glass plate, followed by successively performing chamfering, main surface lapping and edge mirror polishing. Thereafter, the circular glass plates thus processed are laminated, and an inner peripheral edge is etched in some cases. Subsequently, the main surface of the circular glass plate is polished to form a flat and smooth surface, thereby manufacturing the glass substrate.

Further, the main surface lapping step may be divided into a rough lapping step and a precise lapping step, and a shape-processing step (hole-coring in the center of the circular glass plate, chamfering and edge polishing) may be provided between these steps. A chemical strengthening step may also be provided after the main surface lapping step. Incidentally, in the case of manufacturing a glass substrate having no circular hole in the center thereof, hole-coring in the center of the circular glass plate is not needed, as a matter of course.

The main surface lapping is usually performed using an aluminum oxide abrasive or an aluminum oxide-based abrasive, having an average particle size of from 6 to 8 μm. The removal amount (polishing amount) of the thickness of the main surface of the circular glass plate by lapping is usually from 100 to 400 μm.

In the polishing of the main surface, first, the polishing is performed using a polishing slurry containing cerium oxide having an average particle size of from 0.5 to 2.0 μm and a urethane polishing pad to adjust the microwaviness (Wa) measured in a range of 1 mm×0.7 mm under a condition of a wavelength region of λ≦0.25 mm using a three-dimensional surface structure analyzing microscope (for example, NV200 manufactured by Zygo Co., Ltd.), for example, to 1 nm or less. The removal amount of the circular glass plate in the polishing is typically from 20 to 50 μm. When the microwaviness (Wa) is desired to be further decreased, the main surface may be polished with a suede pad and a cerium oxide-containing polishing slurry.

Next, the main surface is polished using a colloidal silica slurry containing a colloidal silica abrasive having a BET average particle size of 40 nm or less, preferably 30 nm or less, and a smoothness index represented by BET average particle size (nm)/circularity of 50 nm or less, preferably 35 nm or less. That is to say, the colloidal silica abrasive used in the invention is fine and closer to a true sphere in shape. Incidentally, the polishing pressure is preferably from 0.5 to 15 kPa, and more preferably 4 kPa or more. When the polishing pressure is less than 4 kPa, the stability of the glass substrate at the time of the polishing unfavorably deteriorates, resulting in a tendency to flop. As a result, there is a concern that the waviness of the main surface becomes large.

Although the kind of colloidal silica is not limited, one manufactured by a water glass method is preferred in terms of cost. Further, the content of the colloidal silica abrasive in the slurry is typically from 5 to 40% by mass, and preferably from 10 to 15% by mass.

The circularity is a value indicated by 4·π·S/L², wherein the area per one particle of the colloidal silica abrasive appearing in a TEM photograph is taken as S, and the outer peripheral length thereof is taken as L. When the colloidal silica abrasive is completely a true sphere, the numerical value becomes 1. When it deviates from the true sphere, the numerical value goes down. The colloidal silica abrasive contained in the slurry varies in particle size and shape. Accordingly, in the invention, the circularity is examined for about 30 particles of the abrasive, and the average value thereof is used. Incidentally, there is no limitation on the circularity as long as the foregoing smoothness index is satisfied. However, it is preferred that the abrasive is closer to the true sphere. Typically, the circularity is preferably from 0.6 to 1.0. The reason for this is that edge portions of the abrasive conceivably cause damage to the substrate to deteriorate the surface roughness Ra.

A medium is a so-called aqueous medium, and the slurry contains water. Further, it may contain a water-soluble anionic or nonionic polymer.

The slurry is preferably used in a metastable region of a so-called dispersion state in which the pH is from 1.5 to 2.5. Further, for pH adjustment, it is preferred that the slurry contains an acid, and the acid is preferably at least one strong acid selected from the group consisting of hydrochloric acid, sulfuric acid, nitric acid and sulfurous acid, in terms of cost.

The polishing pad used typically comprises a foamed urethane resin having a shore D hardness of from 45 to 75, a compressibility of from 0.1 to 10% and a density of from 0.5 to 1.5 g/cm³, a foamed urethane resin having a shore A hardness of from 30 to 99, a compressibility of from 0.5 to 10% and a density of from 0.2 to 0.9 g/cm³, or a foamed urethane resin having a shore A hardness of from 5 to 65, a compressibility of from 0.1 to 60% and a density of from 0.05 to 0.4 g/cm³. Incidentally, the shore A hardness of the polishing pad is preferably 20 or more. When it is less than 20, there is a concern that the polishing rate decreases.

Incidentally, the shore D hardness and the shore A hardness are each measured by methods for measuring durometer A hardness and D hardness of plastics as specified in JIS K7215, respectively. Also, the compressibility (unit: %) is measured in the following manner. That is, with respect to a measuring sample cut out into an appropriate size from the polishing pad, a material thickness t₁ at the time of applying a load of a stress of 10 kPa from a non-loaded state for 30 seconds using a Schopper type thickness gauge is determined; subsequently, a material thickness t₁ at the time of applying a load of a stress of 110 kPa immediately from the state where the thickness is t₀ for 5 minutes is determined; and {(t₀-t₁)×100}/t₀ is then calculated from the t₀ and t₁ values, and this is defined as the compressibility.

Incidentally, in the measurement of the shore D hardness and the shore A hardness of the polishing pad, the polishing pad specimens are laminated, and the hardness thereof is measured. Accordingly, there is a concern that it is improper as the hardness of the polishing pad governing a polishing phenomenon. It is therefore preferred that the hardness measured using an IRHD micro detector of a general-purpose automatic hardness meter for rubber, Digitest, manufactured by H. Barleys Company (hereinafter referred to as the IRHD hardness) is taken as the hardness of the polishing pad. The IRHD hardness of the polishing pad is preferably from 20 to 80.

By the polishing with the foregoing colloidal silica slurry, the main surface of the circular glass plate comes to have a high smoothness in which the surface roughness Ra measured under an atomic force microscope (AFM) is 0.15 nm or less and preferably 0.13 nm or less. The removal amount in this polishing is typically from 0.5 to 2 μm.

After the polishing, cleaning is performed for the purpose of removing the colloidal silica abrasive. Then, the circular glass plate is dried after the cleaning. As a drying method, there is used a drying method using isopropyl alcohol vapor, spin drying, vacuum drying or the like.

The glass substrate of the invention is obtained through the foregoing series of steps. Further, the magnetic recording medium of the invention is obtained by coating the main surface with a magnetic recording layer. The glass substrate has an excellent smoothness, so that high-density recording becomes possible.

### EXAMPLES

The invention will be further described below with reference to Examples and Comparative Examples, but the invention should not be construed as being limited thereto in any way.

(Preparation of Glass Substrate)

A silicate glass plate (Al₂O₃-SiO₂-based glass plate, the contents in terms of mol % were SiO₂: 67.7%, Al₂O₃: 4.9%, MgO: 10.9%, TiO₂: 4%, Na₂O: 4.9% and K₂O: 7.6%) formed by a float process was processed into such a doughnut-shaped circular glass plate (circular glass plate having a circular hole in the center thereof) that a glass substrate having an outer diameter of 65 mm, an inner diameter of 20 mm and a thickness of 0.635 mm was obtained. Incidentally, grinding processing of the inner peripheral surface and the outer peripheral surface was performed using a diamond grindstone, and lapping of top and bottom surfaces of the circular glass plate was performed using an aluminum oxide abrasive.

Subsequently, inner and outer peripheral edges were subjected to chamfering processing to a chamfering width of 0.15 mm and a chamfering angle of 45°. After the processing of the inner and outer peripheral edges, mirror polishing of the edges was performed by brush polishing using a cerium oxide slurry as an abrasive and a brush as a polishing tool. The polishing amount was 30 μm in terms of the removal amount in a radial direction.

Thereafter, polishing processing of the top and bottom main surfaces was performed with a double side polishing machine using a cerium oxide slurry (the average particle size of cerium oxide: about 1.1 μm) as an abrasive and a urethane pad as a polishing tool. The removal amount was 35 μm in total in a thickness direction of the top and bottom main surfaces.

Then, polishing of the main surfaces was performed using the following test slurries A to E.

### (Test Slurry A)

To 1.97 L of distilled water, 10.0 mL of nitric acid was added, followed by stirring. Then, 1.03 L of colloidal silica (trade name: CP20) manufactured by Fujimi Co., Ltd. was added thereto with stirring to prepare a test slurry A. Incidentally, the pH of the slurry was 1.9.

### (Test Slurry B)

To 1.97 L of distilled water, 14.0 mL of nitric acid was added, followed by stirring. Then, 1.03 L of colloidal silica (trade name: HS40) manufactured by Ludox Corporation was added thereto with stirring to prepare a test slurry B. Incidentally, the pH of the slurry was 2.1.

### (Test Slurry C)

To 1.52 L of distilled water, 10.0 mL of nitric acid was added, followed by stirring. Then, 1.48 L of colloidal silica (trade name: SD30) manufactured by Nippon Chemical Industrial Co., Ltd. was added thereto with stirring to prepare a test slurry C. Incidentally, the pH of the slurry was 2.2.

### (Test Slurry D)

To 2.25 L of distilled water, 6.0 mL of nitric acid was added, followed by stirring. Then, 0.75 L of colloidal silica (trade name: ST50) manufactured by Nissan Chemical Industries, Ltd. was added thereto with stirring to prepare a test slurry D. Incidentally, the pH of the slurry was 2.0.

### (Test Slurry E)

To 1.52 L of distilled water, 10.0 mL of nitric acid was added, followed by stirring. Then, 1.48 L of colloidal silica (trade name: SD30LL) manufactured by Nippon Chemical Industrial Co., Ltd. was added thereto with stirring to prepare a test slurry E. Incidentally, the pH of the slurry was 1.9.

Then, the main surfaces of the foregoing circular glass substrate were polished at a polishing pressure of 12 kPa for 20 minutes, using each of the foregoing slurries as an abrasive, using as a polishing tool a polishing pad composed of a foamed polyurethane resin having a shore A hardness of 65.0°, a compressibility of 2.3% and a density of 0.68 g/cm³, and using a 9B double side polishing machine manufactured by Speedfam Co., Ltd.

After the circular glass plate was polished, the following cleaning processes were performed. That is to say, pure water shower cleaning, scrub cleaning with BELLCLEAN and water, scrub cleaning with BELLCLEAN and an alkaline detergent, scrub cleaning with BELLCLEAN and water and pure water shower cleaning were successively performed, followed by air blowing. Thereafter, AFM measurement was performed under an atomic force microscope (AFM) (trade name: SPA400) manufactured by Seiko Instruments Inc. to determine the surface roughness Ra of the main surfaces. The results thereof are shown in Table 1.

Further, for the colloidal silica used in each test slurry, the average particle size obtained by the BET specific surface area measuring method (BET average particle size) was measured. Furthermore, for the circularity, a TEM photograph was taken, the area S and the outer peripheral length L per one particle were measured for 30 particles of the colloidal silica abrasive in a field of view to determine the circularity, and the average value was calculated therefrom. The results thereof are described in Table 1 together.

TABLE 1

| | BET Average | | Smoothness | |
|---|---|---|---|---|
| | Particle Size | | Index | Ra |
| | (nm) | Circularity | (nm) | (nm) |
| Slurry A | 15.0 | 0.6910 | 21.7 | 0.092 |
| Slurry B | 20.7 | 0.6957 | 29.7 | 0.115 |
| Slurry C | 14.3 | 0.6383 | 22.4 | 0.112 |
| Slurry D | 27.4 | 0.7350 | 32.3 | 0.122 |
| Slurry E | 34.9 | 0.6957 | 50.1 | 0.157 |

From Table 1, it is seen that the desired surface roughness Ra of 0.15 nm or less can be satisfied by using the slurries A, B, C and D having a BET average particle size of 40 nm or less and a smoothness index of 50 nm or less.

While the invention has been described in detail with reference to specific embodiments thereof, it will be apparent to one skilled in the art that various changes and modifications can be made therein without departing from the spirit and scope thereof.

Incidentally, the present application is based on Japanese Patent Application No. 2010-103510 filed on Apr. 28, 2010, and the contents are incorporated herein by reference.

Also, all the references cited herein are incorporated as a whole.

According to the present invention, the surface roughness Ra of a glass substrate measured under an atomic force microscope (AFM) is adjusted to 0.15 nm or less by polishing the glass substrate using a colloidal silica abrasive having a BET average particle size of 40 nm or less and a smoothness index of 50 nm or less, and there is provided a glass substrate for an information recording medium which can thoroughly deal with a high recording capacity which will be demanded in the future.

What is claimed is:

1. A colloidal silica slurry used in a method for manufacturing a glass substrate for an information recording medium, said method comprising: a lapping step of lapping a main surface of a circular glass plate; a subsequent cerium oxide polishing step of polishing the main surface of the circular glass plate with a slurry containing a cerium oxide abrasive; and a colloidal silica polishing step of polishing the main surface of the circular glass plate with a slurry containing a colloidal silica abrasive after the cerium oxide polishing step,
wherein the colloidal silica abrasive has a BET average particle size determined by a BET specific surface area measuring method of 40 nm or less, and
a smoothness index represented by a ratio (BET average particle size (nm)/Circularity) of the BET average particle size and a circularity indicated by 4·π·S/L² in which an area per one particle of the colloidal silica abrasive is taken as S and an outer peripheral length thereof is taken as L, of 50 nm or less.

2. The colloidal silica slurry according to claim 1, wherein the colloidal silica slurry has a pH of from 1.5 to 2.5.

3. The colloidal silica slurry according to claim 1, wherein the colloidal silica slurry contains an acid, and the acid is at least one selected from the group consisting of hydrochloric acid, sulfuric acid, nitric acid and sulfurous acid.

4. The colloidal silica slurry according to claim 1, wherein the colloidal silica abrasive is manufactured by a water glass method.

5. The colloidal silica slurry according to claim 1, which is for polishing a circular Al₂O₃-SiO₂-based glass plate.

6. A method for manufacturing a glass substrate for an information recording medium, said method comprising:
a lapping step of lapping a main surface of a circular glass plate;
a cerium oxide polishing step of polishing the main surface of the circular glass plate with a slurry containing a cerium oxide abrasive after the lapping step; and
a colloidal silica polishing step of polishing the main surface of the circular glass plate with the colloidal silica slurry according to claim 1 after the cerium oxide polishing step.

7. The method for manufacturing a glass substrate for an information recording medium according to claim 6, wherein the circular glass plate is a circular Al₂O₃-SiO₂-based glass plate.

8. A glass substrate for an information recording medium obtained by the manufacturing method according to claim 6.

9. The glass substrate for an information recording medium according to claim 8, wherein a main surface of the glass substrate has a surface roughness Ra of 0.15nm or less.

10. A magnetic recording medium comprising a magnetic recording layer provided on the main surface of the glass substrate for an information recording medium according to claim 8.
